(19) United States
(12) Patent Application Publication
(10) Pub. No.: US 2007/0042776 A1
(43) Pub. Date: Feb. 22, 2007

(54) Wireless packet-switched paging apparatus, systems, and methods

(76) Inventors: Sanjay Bakshi, Beaverton, OR (US); Sameer Pareek, Portland, OR (US); Bala Rajagopalan, Beaverton, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/208,427

(22) Filed: Aug. 19, 2005

(51) Int. Cl. H04Q 7/20

(52) U.S. Cl. 455/435.1; 370/318; 455/433

(57) ABSTRACT

Embodiments of wireless packet-switched paging apparatus, systems, and methods are described generally herein. Other embodiments may be described and claimed.

### TECHNICAL FIELD

Various embodiments described herein relate to digital communications generally, including apparatus, systems, and methods used to localize a mobile node and to direct a packet stream thereto.

### BACKGROUND INFORMATION

Emerging wireless network technologies may include wireless networks designed with a packet-switched architecture. Such network may be referred to herein as a wireless packet-switched network (WPSN). A mobile wireless device (“mobile node”) operating within a WPSN may be capable of communicating a variety of media, including perhaps data, voice, and video, among others. Internet protocol (IP) datagrams may be utilized.

The WPSN may support mobility operation. That is, the mobile node may operate in an area of radio-frequency (RF) coverage associated with a first base station to which the mobile node has attached via a wireless protocol. The mobile node may engage in a packet exchange session (e.g., a transfer control protocol session) with another network node. The mobile node may then move from the area of RF coverage associated with the first base station to an area of RF coverage associated with a second base station without disconnecting the packet exchange session.

The mobile node may update the network with its current location by sending a registration message when it transitions from the first base station to the second base station. This may result in a large number of control messages in a WPSN supporting a large population of mobile nodes. The problem may be compounded as a number of base stations per unit area of RF coverage increases. Since data transmission may be bursty in nature, the mobile node may be required to send location updates as a user moves around in the WPSN even when no packet exchange session is in process. The mobile node may experience reduced operating time between battery charges as a result.

### BRIEF DESCRIPTION OF THE DRAWINGS

FIG. 1 is a block diagram of an apparatus and a representative system according to various embodiments of the invention.

FIGS. 2A and 2B are flow diagrams illustrating several methods according to various embodiments of the invention.

FIG. 3 is a block diagram of an article according to various embodiments of the invention.

### DETAILED DESCRIPTION

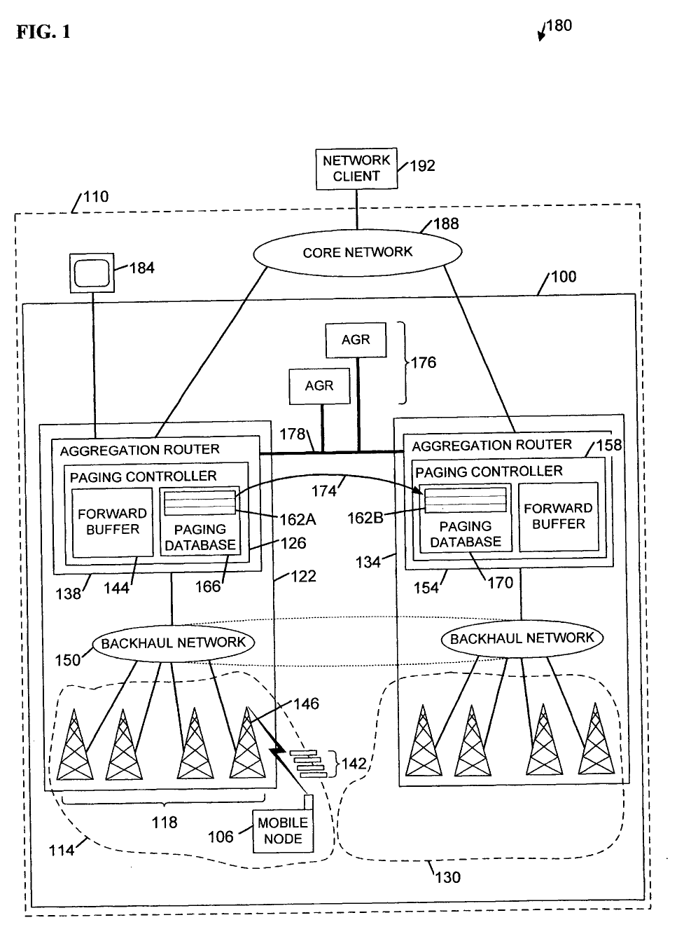

FIG. 1 comprises a block diagram of an apparatus 100 and a system 180 according to various embodiments of the invention. Some embodiments may inhibit or decrease a frequency of location updates from a mobile node 106 operating in a WPSN 110. The location updates may be inhibited or decreased while the mobile node 106 moves within an area of RF coverage 114 associated with one or more base stations 118. The base stations 118 may be associated with a portion of a WPSN referred to herein as a paging group (e.g., first paging group 122). A paging controller associated with the paging group (e.g., first paging controller module 126) may cause a paging advertisement directed to the mobile node 106 to be broadcast by the base station(s) 118 within the paging group 122. The paging advertisement may query the mobile node 106 for its location and may advise the mobile node 106 of pending data.

Limiting transmission of a paging advertisement to a paging group may conserve spectrum resources. In some embodiments of the invention, the WPSN 110 may be divided into paging groups based upon various system factors. These may include base station density relative to expected mobile node traffic, among others. The mobile node 106 may thus update the WPSN 110 when it moves from the first area of RF coverage 114 associated with the first paging group 122 to a second area of RF coverage 130 associated with a second paging group 134. The WPSN 110 may localize the mobile node 106 to a particular paging group, without tracking movement of the mobile node 106 from one base station to another within the particular paging group. Some embodiments may support adjustment of a granularity of paging localization using this architecture.

A paging group (e.g., 122 or 134) may thus provide a contiguous coverage region within which the mobile node 106 need not be required to transmit in an uplink direction, but can be paged in the downlink direction if necessary. For example, the mobile node 106 may be paged in the downlink direction so that the paging group may forward pending traffic to the mobile node 106 or perform network management service transactions with the mobile node 106. Some embodiments of the invention may conserve scarce power resources in the mobile node 106 while conserving spectral resources within the WPSN 110 using disclosed architectures.

Example embodiments may be described wherein a separate paging controller may be associated with each of several paging groups. However, it should be noted that in some embodiments a paging controller may control paging in more than one paging group.

The apparatus 100 may further include a first aggregation router 138 within the first paging group 122 associated with the WPSN 110. The first paging controller module 126 may be located within the first aggregation router 138, and may localize the mobile node 106 to the first paging group 122. The mobile node 106 may operate according to a power management protocol within the first RF coverage area 114 corresponding to the first paging group 122. The power management protocol may include placing the mobile node 106 in an idle state for an idle period and paging the mobile node 106 when required, as previously mentioned.

A packet stream 142 may be buffered, perhaps in a forward buffer 144 associated with the first paging controller module 126. The packet stream 142 may also be routed by the first aggregation router 138 from a source outside of the first paging group 122. The first paging controller module 126 may direct the packet stream 142 to the mobile node 106. The apparatus 100 may also include a paging base station 146 to couple to the mobile node 106 to advise the mobile node 106 that the packet stream 142 is pending delivery. A backhaul network 150 may be coupled to the paging base station 146 to deliver the packet stream 142 to the paging base station 146. The backhaul network 150 may aggregate traffic from the base station(s) 118. In some embodiments the backhaul network 150 may aggregate traffic from base stations associated with more than one paging group.

The apparatus 100 may also include a second aggregation router 154 associated with the second paging group 134 to communicatively couple to the first aggregation router 138. The second aggregation router 154 may receive the packet stream 142 from the first aggregation router 138 when the mobile node 106 moves from the first RF coverage area 114 to the second RF coverage area 130.

A second paging controller module 158 within the second aggregation router 154 may communicatively couple to the first paging controller module 126. One or more paging group identification parameters, generally shown as 162A and 162B, may be associated with the mobile node 106. The paging group identification parameter(s) 162A and 162B may be transferred from a first paging database 166 maintained by the first paging controller module 126 to a second paging database 170 maintained by the second paging controller module 158. The transfer 174 may occur when the mobile node 106 moves from the first RF coverage area 114 to the second RF coverage area 130. The paging group identification parameter(s) 162A and 162B may comprise a paging controller identification, a paging group identification, and an identification associated with an aggregation router originating the packet stream 142 (e.g., the first aggregation router 138).

The apparatus 100 may also include one or more additional aggregation routers 176. The additional aggregation router(s) 176 may couple additional paging groups to the first paging group 122 using a network backbone 178.

In another embodiment, a system 180 may include one or more of the apparatus 100, as previously described. The system 180 may also include a display 184 to couple to the first aggregation router 138 to perform configuration operations. The display 184 may comprise a cathode ray tube display or a solid-state display such as a liquid crystal display, a plasma display, or a light-emitting diode display, among other types: In some embodiments, the first aggregation router 138 may be coupled to a core network 188. The first aggregation router 138 may receive the packet stream 142 from a network client 192 communicatively coupled to the core network 188.

Any of the components previously described can be implemented in a number of ways, including embodiments in software. Thus, the apparatus 100; mobile node 106; wireless packet-switched network (WPSN) 110; areas of RF coverage 114, 130; base stations 118, 146; paging groups 122, 134; paging controller modules 126, 158; aggregation routers 138, 154, 176; packet stream 142; forward buffer 144; backhaul network 150; paging group identification parameters 162A, 162B; paging databases 166, 170; transfer 174; network backbone 178; system 180; display 184; core network 188; and network client 192 may all be characterized as “modules” herein.

The modules may include hardware circuitry, single or multi-processor circuits, memory circuits, software program modules and objects, firmware, and combinations thereof, as desired by the architect of the apparatus 100 and system 180 and as appropriate for particular implementations of various embodiments.

It should also be understood that the apparatus and systems of various embodiments can be used in applications other than using a paging controller located in an aggregation router within a wireless packet-switched network to page a mobile node. Thus, various embodiments of the invention are not to be so limited. The illustrations of apparatus 100 and system 180 are intended to provide a general understanding of the structure of various embodiments. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, and others. Some embodiments may include a number of methods.

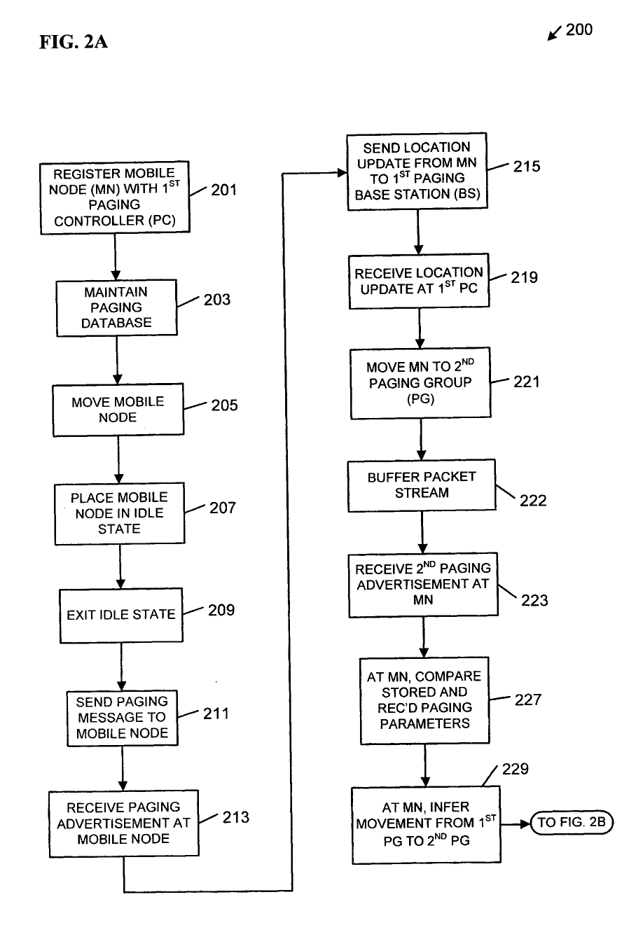

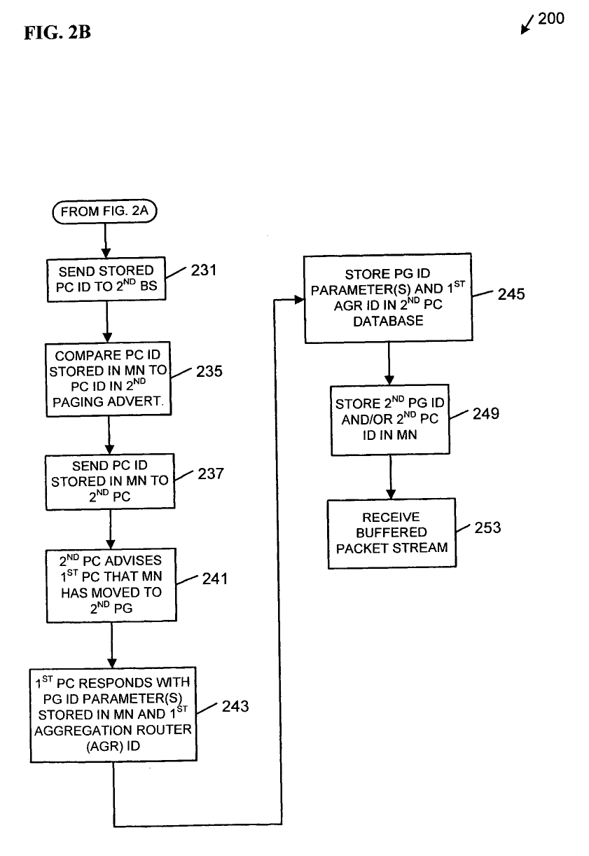

FIGS. 2A and 2B are a flow diagram representation illustrating several methods according to various embodiments of the invention. A method 200 may include localizing a mobile node (MN) operating according to a power management protocol to a first paging group within a WPSN. A first paging controller module located within a first aggregation router associated with the first paging group may perform the localization operation. The first paging controller module may also cause a packet stream to be directed to the mobile node. The power management protocol may comprise activities associated with the method 200, particularly activities defined in this specification as associated with blocks 201-219.

The method 200 may begin with registering the mobile node with the first paging controller module before the mobile node enters an idle state, at block 201. The method 200 may continue at block 203 with maintaining a first paging database using the first paging controller module. The first paging database may include one or more entries representing the mobile node. The entries may include parameters associated with a relationship between the mobile node and the WPSN. The parameters may include a paging controller identification, a paging group identification, and an identification associated with the first aggregation router, among others. The first aggregation router may comprise an aggregation router from which the packet stream originates. The first paging database may be maintained by the first paging controller module while the mobile node moves within the first paging group, including perhaps when the mobile node is in an idle state.

The method 200 may also include moving the mobile node within an area of RF coverage associated with the first paging group, at block 205. In some embodiments, the mobile node may be moved without performing a location update unless the mobile node is paged. The method 200 may continue at block 207 with placing the mobile node in an idle state for an idle period. The mobile node may exit the idle state following the idle period, at block 209.

The method 200 may include providing a paging message to the mobile node upon command from the first paging controller module, at block 211. The paging message may comprise a first paging advertisement triggered by the first paging controller module and received at the mobile node from a first paging base station, at block 213. In some cases, the mobile node may receive the first paging advertisement upon exiting the idle state. The method 200 may also include sending a location update message from the mobile node to the first paging base station in response to the first paging advertisement, at block 215. The location update may be received at the first paging controller module, at block 219.

The method 200 may continue at block 221 with moving the mobile node from a first area of RF coverage associated with the first paging group to a second area of RF coverage associated with a second paging group. A packet stream pending for the mobile node may be buffered within the network while the mobile node moves between the first paging group and the second paging group, at block 222. The pending packet stream may be buffered in the first paging controller module in some embodiments. In some embodiments the pending packet stream may be buffered in a second paging controller module within a second aggregation router associated with the second paging group.

A second paging advertisement may be received at the mobile node from a second paging base station located in the second paging group, at block 223. The mobile node may compare a paging controller identification or a paging group identification associated with the second paging advertisement to a paging controller identification or a paging group identification stored in the mobile node, respectively, at block 227. The mobile node may infer from the comparison that it has moved from the first area of RF coverage to the second area of RF coverage, at block 229.

The method 200 may also include communicating the paging controller identification stored in the mobile node to the second paging base station, at block 231. At the second paging base station, the paging controller identification stored in the mobile node may be compared to the paging controller identification associated with the second paging advertisement, at block 235. The second paging base station may recognize that the paging controller identification stored in the mobile node and the paging controller identification associated with the second paging advertisement are different. The second paging base station may consequently communicate the paging controller identification stored in the mobile node to the second paging controller module within the second aggregation router associated with the second paging group, at block 237.

The method 200 may further include communicating from the second paging controller module to the first paging controller module. The second paging controller module may advise the first paging controller module that the mobile node has moved to the second paging group, at block 241. The second paging controller module may receive a response from the first paging controller module. The response may include one or more paging group identification parameters stored in the mobile node and an identification associated with the first aggregation router, at block 243. Communications between the first paging controller module and the second paging controller module may traverse a backhaul network, a network backbone, or both.

The method 200 may include storing the paging group identification parameter(s) and the identification associated with the first aggregation router in a second paging database associated with the second paging controller module, at block 245. A second paging group identification associated with the second paging group, a second paging controller identification associated with the second paging controller module, or both may be updated and stored within the mobile node, at block 249. The method 200 may conclude with receiving one or more packets buffered in the first paging controller module, at block 253.

The method 200 may thus establish a packet stream forwarding route between the first aggregation router and the second aggregation router upon moving the mobile node from the first paging group to the second paging group. In some embodiments the packet stream forwarding route may comprises an Internet protocol tunnel. The first and second paging controller modules may perform other operations, including those defined by a mobile-Internet protocol (mobile-IP), an Institute of Electrical and Electronic Engineers (IEEE) 802.16e protocol, or both. Additional information regarding mobile-IP may be found in Internet Engineering Task Force (IETF) Request for Comments (RFC) 3344 “IP Mobility Support for IPv4” (August, 2002) and related RFCs. Additional information regarding IEEE 802.16e, a standard not yet finalized at the time of this application, may be found at the IEEE 802.16 Task Group e (Mobile WirelessMAN®) website, http://www.ieee802.org/16/tge/.

It may be possible to execute the activities described herein in an order other than the order described. And, various activities described with respect to the methods identified herein can be executed in repetitive, serial, or parallel fashion.

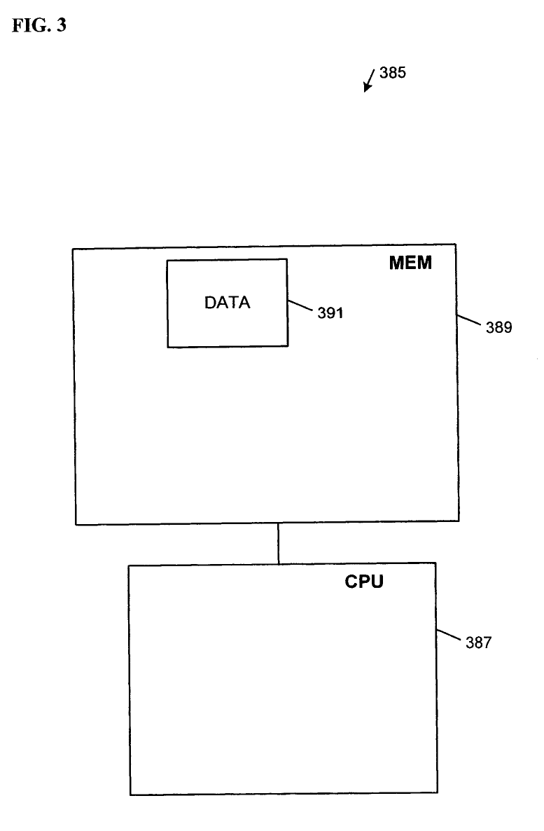

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 3 below.

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) such as a central processing unit (CPU) 387 coupled to a machine-accessible medium such as a memory 389 (e.g., a memory including electrical, optical, or electromagnetic elements). The medium may contain associated information 391 (e.g., computer program instructions, data, or both) which, when accessed, results in a machine (e.g., the CPU 387) performing the activities previously described.

Implementing the apparatus, systems, and methods disclosed herein may provide a contiguous paging region within a WPSN. A mobile node may be localized within the WPSN to a paging group, and a pending packet stream may be delivered across the WPSN to the mobile node. Disclosed architectures may conserve mobile node power and system spectral resources.

Although the inventive concept may include embodiments described in the exemplary context of an 802.xx implementation (e.g., 802.11, 802.11a, 802.11g, 802.11n, 802.11 HT, 802.16, etc.), the claims are not so limited. Embodiments of the present invention may be implemented as part of any wired or wireless system Examples may also include embodiments comprising multi-carrier wireless communication channels (e.g., OFDM, DMT, etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method, including:
localizing a mobile node operating according to a power management protocol to a first paging group within a wireless packet-switched network using a first paging controller module within a first aggregation router associated with the first paging group; and
directing a packet stream to the mobile node using the first paging controller module.

2. The method of claim 1, wherein the power management protocol includes:
placing the mobile node in an idle state for an idle period;
exiting the idle state following the idle period;
receiving a first paging advertisement at the mobile node from a first paging base station upon exiting the idle state, the first paging advertisement triggered by the first paging controller module; and
sending a location update message from the mobile node to the first paging base station in response to the first paging advertisement.

3. The method of claim 2, further including:
upon exiting the idle state, receiving at the mobile node at least one packet buffered in the first paging controller module.

4. The method of claim 1, further including:
registering the mobile node with the first paging controller module before the mobile node enters an idle state.

5. The method of claim 1, further including:
maintaining a first paging database using the first paging controller module, wherein the first paging database includes at least one entry representing the mobile node, the at least one entry to be maintained while the mobile node is in an idle state.

6. The method of claim 5, wherein the at least one entry comprises at least one of a paging controller identification, a paging group identification, and an identification associated with the first aggregation router, wherein the first aggregation router originates the packet stream to be directed to the mobile node.

7. The method of claim 1, further including:
moving the mobile node within an area of radio-frequency coverage associated with the first paging group without performing a location update unless the mobile node is paged.

8. The method of claim 1, further including:
providing a paging message to the mobile node upon command from the first paging controller module; and
receiving a location update from the mobile node at the first paging controller module in response to the paging message.

9. The method of claim 1, further including:
moving the mobile node from a first area of radio-frequency (RF) coverage associated with the first paging group to a second area of RF coverage associated with a second paging group;
receiving a second paging advertisement at the mobile node from a second paging base station located in the second paging group;
at the mobile node, comparing at least one of a paging controller identification associated with the second paging advertisement and a paging group identification associated with the second paging advertisement to at least one of a paging controller identification stored in the mobile node and a paging group identification stored in the mobile node, respectively; and
at the mobile node, inferring from the comparison that the mobile node has moved from the first area of RF coverage to the second area of RF coverage.

10. The method of claim 9, further including:
communicating the paging controller identification stored in the mobile node to the second paging base station;
at the second paging base station, comparing the paging controller identification stored in the mobile node to the paging controller identification associated with the second paging advertisement; and
upon recognizing that the paging controller identification stored in the mobile node and the paging controller identification associated with the second paging advertisement are different, communicating the paging controller identification stored in the mobile node from the second paging base station to a second paging controller module within a second aggregation router associated with the second paging group.

11. The method of claim 10, farther including:
communicating from the second paging controller module to the first paging controller module to advise the first paging controller module that the mobile node has moved to the second paging group;
receiving a response at the second paging controller module from the first paging controller module including at least one paging group identification parameter stored in the mobile node and an identification associated with the first aggregation router, wherein the first aggregation router originates the packet stream to be directed to the mobile node;
storing the at least one paging group identification parameter and the identification associated with the first aggregation router in a second paging database associated with the second paging controller module; and
updating and storing within the mobile node at least one of a second paging group identification associated with the second paging group and a second paging controller identification associated with the second paging controller module.

12. The method of claim 11, wherein communications between the first paging controller module and the second paging controller module traverse at least one of a backhaul network or a network backbone.

13. The method of claim 1, further including:
establishing a packet stream forwarding route between the first aggregation router and a second aggregation router associated with a second paging group upon moving the mobile node from a first area of radio-frequency (RF) coverage associated with the first paging group to a second area of RF coverage associated with the second paging group.

14. The method of claim 13, wherein the packet stream forwarding route comprises an Internet protocol tunnel.

15. The method of claim 1, further including:
buffering the packet stream while the mobile node moves between the first paging group and a second paging group.

16. The method of claim 15, wherein the packet stream is buffered in the first paging controller module.

17. The method of claim 15, wherein the packet stream is buffered in a second paging controller module within a second aggregation router associated with the second paging group.

18. The method of claim 1, further including:
performing an operation defined by at least one of a mobile-Internet protocol or an Institute of Electrical and Electronic Engineers 802.16e protocol using the first paging controller module.

19. An article including a machine-accessible medium having associated information, wherein the information, when accessed, results in a machine performing:
localizing a mobile node operating according to a power management protocol to a first paging group within a wireless packet-switched network using a first paging controller module within a first aggregation router associated with the first paging group; and
directing a packet stream to the mobile node using the first paging controller module.

20. The article of claim 19, wherein the information, when accessed, results in a machine performing:
maintaining a first paging database using the first paging controller module, wherein the first paging database includes at least one entry representing the mobile node, the at least one entry to be maintained while the mobile node is in an idle state.

21. The article of claim 19, wherein the information, when accessed, results in a machine performing:
providing a paging message to the mobile node upon command from the first paging controller module; and
receiving a location update from the mobile node at the first paging controller module in response to the paging message.

22. An apparatus, including:
a first aggregation router within a first paging group associated with a wireless packet-switched network; and
a first paging controller module within the first aggregation router to localize a mobile node to the first paging group and to direct a packet stream to the mobile node, wherein the mobile node operates according to a power management protocol within a first radio-frequency (RF) coverage area corresponding to the first paging group.

23. The apparatus of claim 22, further including:
a paging base station to couple to the mobile node to advise the mobile node that the packet stream is pending delivery.

24. The apparatus of claim 22, further including:
a backhaul network coupled to the paging base station to deliver the packet stream to the paging base station.

25. The apparatus of claim 22, further including:
a second aggregation router associated with a second paging group to communicatively couple to the first aggregation router to receive the packet stream when the mobile node moves from the first RF coverage area to a second RF coverage area associated with the second paging group.

26. The apparatus of claim 25, further including:
a second paging controller module within the second aggregation router to communicatively couple to the first paging controller module to transfer at least one paging group identification parameter associated with the mobile node from a firs paging database maintained by the first paging controller module to a second paging database maintained by the second paging controller module, the transfer to occur when the mobile node moves from the first RF coverage area to the second RF coverage area.

27. The apparatus of claim 26, wherein the at least one paging group identification parameter comprises at least one of a paging controller identification, a paging group identification, and an identification associated with the first aggregation router, and wherein the first aggregation router originates the packet stream.

28. A system, including:
a first aggregation router within a first paging group associated with a wireless packet-switched network;
a first paging controller module within the first aggregation router to localize a mobile node to the first paging group and to direct a packet stream to the mobile node, wherein the mobile node operates according to a power management protocol within a first radio-frequency (RF) coverage area corresponding to the first paging group; and
a solid-state display to couple to the first aggregation router to perform configuration operations.

29. The system of claim 28, wherein the first aggregation router is coupled to a core network to receive the packet stream from a network client communicatively coupled to the core network.

30. The system of claim 29, further including:
at least one additional aggregation router to couple additional paging groups to the first paging group using a network backbone.
